(19) United States
(12) Patent Application Publication
(10) Pub. No.: US 2014/0235313 A1
(43) Pub. Date: Aug. 21, 2014

(54) Lottery Game Market with Developer Network

(71) Applicant: GTECH CORPORATION, Providence, RI (US)

(72) Inventor: Thomas J. Napolitano, East Greenwich, RI (US)

(73) Assignee: GTECH Corporation, Providence, RI (US)

(21) Appl. No.: 13/770,406

(22) Filed: Feb. 19, 2013

(51) Int. Cl. G07F 17/32

(52) U.S. Cl. CPC G07F 17/329; G07F 17/3244
USPC 463/17; 463/42

(57) ABSTRACT

Versatile and comprehensive systems and methods are provided for developing, testing, housing and distributing lottery game offerings, in embodiments of the present invention, a lottery developer network, a game market and a production engine are provided. The lottery developer network supplies a complete development and testing environment to game developers, and the game market provides lottery operators such as government lotteries with access to a vast interactive game library for selection and customization. A game production engine in accordance with the present invention facilitates the rapid selection and implementation of interactive lottery games.

### FIELD OF THE INVENTION

The present invention relates to lottery games, and more particularly to systems and methods for game developers and game operators to manage the creation, offering, selection and customization of games.

### BACKGROUND

Regulated wagering games are common throughout the world. Typical examples are various games offered by state lotteries. Those games, which are offered on a large scale, are operated using centralized transaction processing systems to collect and/or redeem wagers. Most state lotteries and similar entities operate their own central host system, or have it operated by a contractor such as GTECH Corporation. The host systems are typically located within the jurisdiction of the lottery provider. The state lotteries also deploy their own client equipment to operate various channels for delivering games to player customers, such as agent-operated lottery game sales terminals, unattended lottery game sales terminals, vending machines, kiosks, electronic access via the Internet from personal computers, mobile phone access, and interactive TV terminal access, for example. They also operate, or have operated on their behalf by a contractor, their own customized administration systems, such as accounting, reporting, fraud control and prize redemption systems, for example.

Deploying new games on state lottery systems or in other gaming operations typically requires significant custom programming and the rollout of new features in all the various customized administration systems. This can take large amounts of time and resources. When a lottery has a successful new game, other lotteries want to emulate the game, which can then require additional custom work.

There are a few examples of multi-jurisdictional games, but generally, when the same game is offered in multiple jurisdictions, each jurisdiction has its own implementation, which may include variations to the business rules or play style, for example. Even for multi-jurisdictional games like Powerball, each jurisdiction that participates has its own instantiation of the game and the process of determining winners for the shared jackpot is done separately in each jurisdiction, often with an exchange of data via fax or email for winning numbers and share values, for example.

U.S. Patent Application Publication No. 2009/0143128 to Cautley et al. which is incorporated by reference herein in its entirety, describes systems and methods for providing centralized services to game operators, including back-office systems and customer relationship management (CRM) tools for managing player information.

The present invention provides versatile and comprehensive systems and methods for developing, testing, housing and distributing lottery game offerings which overcome past game development and selection option challenges in embodiments of the present invention, a lottery developer network., a game market and a production engine are provided. The lottery developer network supplies a complete development and testing environment to game developers, in various embodiments of the present invention. The game market provides lottery operators such as government lotteries with access to a vast interactive game library for selection and customization, and a game production engine for facilitating the rapid selection and implementation of games, in accordance with various embodiments of the present invention. Further, a player portal associated with aspects of the present invention provides selected games to players, the end consumers.

### BRIEF DESCRIPTION OF THE DRAWINGS

FIG. 1 illustrates a lottery developer network in accordance with example embodiments of the present invention.

FIG. 2 illustrates a game market according to an example embodiment of the present invention.

FIG. 3 illustrates a sample lottery operator interface for the production engine according to an example embodiment of the present invention.

FIG. 4 is a flow diagram illustrating one method for a lottery operator to select a game for implementation.

### DETAILED DESCRIPTION OF EXAMPLE EMBODIMENTS

The present invention addresses growing demand by lottery customers for expanded gaming options and new gaming concepts. The present invention includes example embodiments providing methods and systems for providing a shared centralized gaming host or market which provides programming and interfaces for customized selection and creation of lottery and other wagering games by the operator of the shared host, the various lotteries or game operators, and third parties, Game operators can choose to activate any or all of the deposited game software and customize the deposited games in a limited way for use in their jurisdiction. Operations procedures may also be standardized and shared in some parts of the system. In this way, content developed by or for one game operator may more easily he transferred, customized, and re-used by other gaming operators, reducing the time and cost needed to develop and deploy new game content and facilitating an increase in the number of types of games which are available to game players. These example embodiments make it easier to provide new games and game content to lottery operators, which in turn may help lotteries acquire new players and increase sales to existing players. These example embodiments help lotteries select, employ, add to, remove and otherwise customize the games they want to offer to customers/players,

In some example embodiments of the present invention, systems are provided that contain a suite of applications residing on a network, provided by a service provider. Game applications and content can be provided and owned by the creators of the content, including the various game operators. Providing content from different sources generally increases the amount of choice which is available to both game operators and to game players. To help increase the number of available games, the present invention empowers content providers to participate in developing new gaming content and broadens the access to their content. For example, content such as new games or new presentation schemes for existing games can be provided by existing game operators, and external developers such as video game companies, music and video producers, owners of well-known branded properties such as sports leagues or game and toy companies, for example. By providing new approaches to deployment of content, example embodiments of the present invention facilitate the increase in available content.

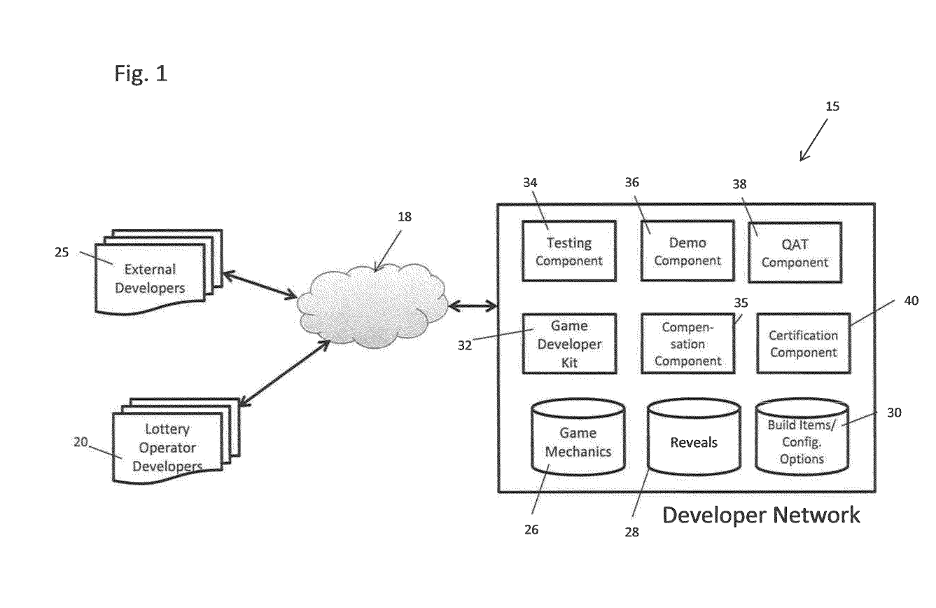

As shown in FIG. 1, the present invention provides, in part, a lottery developer network 15 that can be hosted by an operator of a shared host system, for example. Shared host configurations and architectures for lottery systems are described, for example, in U.S. Patent Application Publication No. 2009/0143128 to Cautley et al.

The lottery developer network 15 of the present invention provides a comprehensive game development and testing environment where internal 20 and external 25 developers can produce imaginative and entertaining games. The developers 20, 25 can access the lottery developer network 15 via a network 18 such as a secure internet, virtual private network, high speed satellite network, or dedicated lines, for example. The lottery developer network 15 can include, for example, documentation, design templates, pay-out thresholds, user forums, application programming interfaces (APIs) and other build items and configuration options 30 that a developer needs or appreciates in order to bring a game concept or design project to fruition. Reveal elements, in one embodiment of the present invention, are the game interfaces such as graphics, animations and sound, for example, that enhance the play experience for the player, whether the player is playing on a game terminal in a gaming location, a home computer or a mobile computing device, such as a smart phone, tablet computer or similar device, for example. It will be appreciated that both games and reveals require relatively continuous refreshing and enhancement in order to maintain player appeal. As such, in embodiments of the present invention, a compensation component 35 is also employed to ensure appropriate rewards for game developers and to entice the best game developer talent to contribute, Developers 20, 25 can contribute to game mechanics as well as to game presentation or reveal elements via a game developer kit (GDK) 32. Further, developers can test their developments via testing component 34 and can demonstrate their developments via demonstration component 36,

Once a developer completes design of a game in the lottery developer network 15 of the present invention, the lottery operator and/or a contractor acting on its behalf can place the game through rigorous quality assurance testing via QAT component 38 to ensure it meets lottery customer expectations. The present invention can provide, in different embodiments, a certification component 40 for certifying for lottery customers that any certified game meets industry and lottery requirements in order to finalize the game for selection and customization by the game market component of the present invention.

In one aspect, the present invention thus provides a method for facilitating presentation layer development for interactive lottery games, including providing a developer network 15 in communication with one or more presentation layer developers (e.g., 20, 25); providing a shared library 26 of game mechanics for selection by the one or more presentation layer developers; providing a shared library 30 of available configuration options for the selected game mechanic including one or more prize structure setting options; and receiving a presentation layer integrated with a game mechanic from a presentation layer developer. The received presentation layer can be stored in a presentation layer database 28 for use, and the combined presentation layer integrated with game mechanic can he subjected to testing and certification by QAT component 38 and certification component 40, respectively.

In one embodiment of the present invention, the received presentation layer integrated with a game mechanic can include a list of at least one supported configuration option from the developer. Such a configuration option can include, for example, special licensing requirements, inclusion into progressive jackpots, grid definition, odds definition, payout amount, launch date and end date. Such a configuration option can further include, for example, the types of game mechanics with which the presentation layer might most suitably be adapted. For example, a presentation layer might be best adapted to a match 3-of-5 or match 3-of-7 game, and such instructions can be provided as part of the received presentation layer. In another embodiment of the present invention, the received presentation layer can be integrated with a game mechanic that is pre-assigned to a price for a wager, such as $1 per wager, for example. In another embodiment of the present invention, the received presentation layer can be integrated with a game mechanic that has more than one result for a wager request, such as a main game and a bonus game, for example,

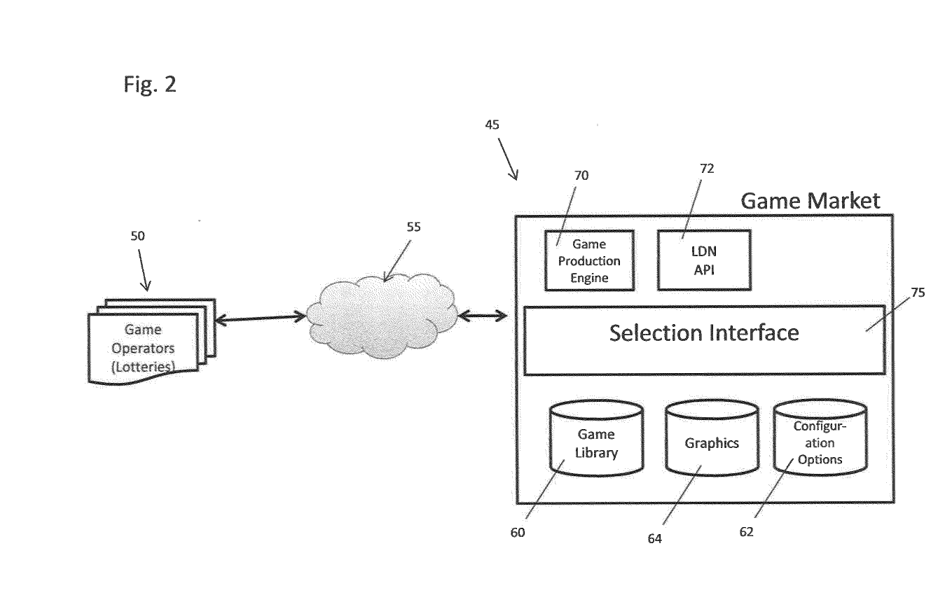

The game market component 45 of the present invention, illustrated in FIG. 2, provides a dynamic, centralized, interactive game library 60, among other things. The game market 45 can provide an unlimited number of game offerings for selection and customization by lottery providers 50. The providers 50 can access the game market component 45 via a network 55 such as a secure internet, virtual private network, high speed satellite network, or dedicated lines, for example, and the games can be provided via a lottery developer network application programming interface 72. In various embodiments of the present invention, the user interface or portal to the game market provides the user 50 (e,g., the government lottery provider) with access to an interactive game library or catalog 60, a library of game configuration options 62, developer information, supporting graphics 64 (e.g., for website displays, marketing collateral, promotional support), game demonstrations, game reviews and certification support. In one embodiment of the present invention, the developer information, game demonstrations, game reviews and certification support can be provided as part of library 60, for example. It will be appreciated that information as to how a game is played and how a game is won is also provided as part of catalog 60. Further, game library 60 can include software code and libraries, presentation information, configuration information, and other information necessary for presentation and use of a game, including a presentation layer integrated with a game mechanic for each game. The game library can also provide a security system that can control access to the games. In addition, the game library can provide an interface through which the games can be accessed in various embodiments of the present invention, the game configuration options can include, without limitation, settings for prize tiers, prize structures, game parameters, game launches and more. In this way, the present invention provides a lottery provider with the fastest way to bring interactive lottery games to market.

As part of the present invention, a game production engine 70 is provided whereby selected games can be loaded into the system as an electronic grid via selection interface 75. Selection interface 75 can assist provider 50 with selecting a game from the library based upon its odds, grid, game type, reveal type and whether a progressive jackpot is involved, for example. Further, selection interface can permit filtering by presentation theme, price point, creation date and performance history, for example. Games can include electronic instant games, including electronic instant keno games, electronic instant Bingo games, electronic extended play games, skill games, partial skill games and others, for example. Electronic extended play games can include, for example, mini-games that take slightly longer to play than an instant game, such as an electronic instant Bingo game where the player can follow along with drawn Bingo numbers and mark off multiple virtual score cards, for example in one embodiment of the present invention, games include seasonally themed games, popular culture themed games, and licensed content games, for example.

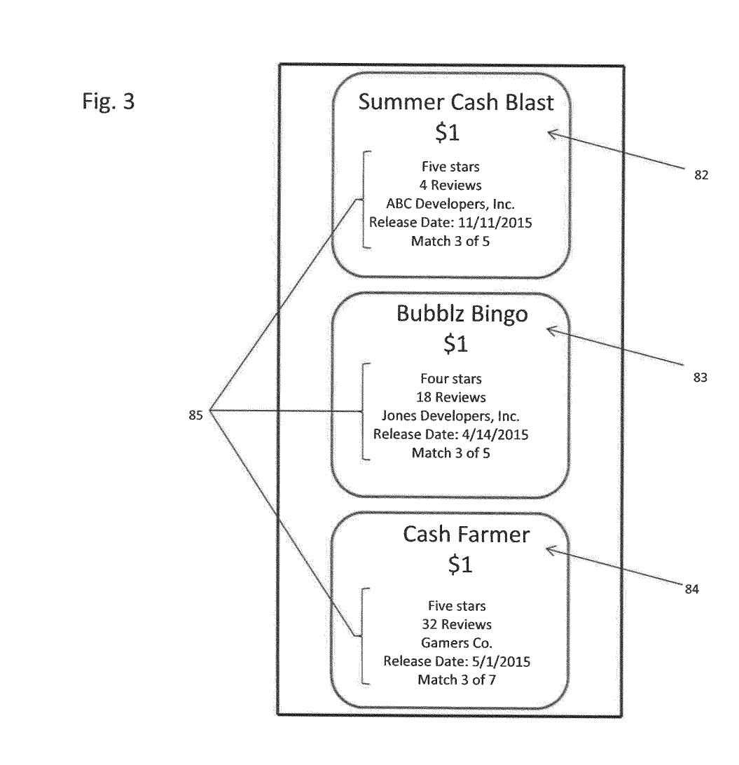

As shown in FIG. 3, for example, a user interface 80 can provide several available reveal options 82, 83, 84 describing the game and cost per wager. Other information 85 can be provided such as a rating, number of reviews, developer name, release date and game type, for example.

As instant games are pre-determined games of chance, the outcome is determined at the point of purchase and typically revealed in the form of an interactive, animated sequence. None of the player's decisions or actions has any impact on the outcome of the game. Electronic instant tickets can be distributed just like traditional paper-based instant tickets, where a pool of tickets is created and one-by-one that pool is diminished (i.e., a “dynamic” grid). Alternatively, and based purely on statistical odds, a pool of tickets is created and there are no changes to the pool as tickets are sold (i.e., a “static” grid), Dynamic grids include, for example, top tier replenishment, top tier replacement, and grid sell-out replacement in any case, a random number generator (RNG) determines the outcome according to the probabilities defined for the game. In this embodiment, the present invention returns a single scenario wager option is picked by the RNG and returned to the player to play out to the pre-determined result. For example, in a pick-three-of-six game, the scenario might be $5, $10, $1,000, $5, $3, $5. With three instances of $5, the player would win $5.

It will be appreciated that the present invention can incorporate games of skill and/or pseudo-games of skill in addition to games that are purely of chance in this way, the present invention can incorporate more than one scenario to be returned to the user for a single game. For instance, a game of skill can be presented to a player whereby they have the chance to earn a key to a treasure chest depending upon their skill as demonstrated in the skill game. Limits can be placed upon the number of keys available to be won. The skill game can be any of a variety of skill games, including black jack (where “hit” or “no hit” decisions involve a level of card-playing skill), hole-in-one golf games where the user attempts to interact with a user interface according to game rules (e.g., proper velocity and aim on a touch-screen interface, or proper key selection on a keypad interface, etc.) in order to make a “hole in one” and earn a key. If the maximum number of keys in a given embodiment of the present invention is ten, some players will earn zero keys, some will earn one key, some will earn two keys, etc., on up to as many as ten keys. Once the skill portion of the game is concluded, the player can then take the number of keys won and open the same number of treasure chests. If there are thirty treasure chests, then a player who was won ten keys will be able to open one-third of the total number of chests.

In this embodiment of the present invention, a single game result will not work as it does in a pure chance game as outlined above. Rather, this embodiment of the present invention requires scenario data for each possible result of the skill game. Thus, an example scenario with ten available keys can be: Win I key, win $5 through the single treasure chest selected; Win 2 keys, win $0 through the first selected treasure chest and $5 through the second selected treasure chest; Win 3 keys, win $2 through the first selected treasure chest, $2 through the second selected treasure chest, and $1 through the third selected treasure chestcontinuing on through ten keys and prizes for each selected treasure chest.

With the present invention's game production engine, each game can be loaded into the system as a grid, which is a logical pool of tickets comprised of the total winning and non-winning tickets in accordance with the above description. When a ticket is purchased, the game application randomly selects the tier (winning or non-winning) for the ticket from the game grid. One method for managing grids includes a “grid switch”, which involves the migration of a game from a single iteration of a grid to a new iteration of a grid based on a grid trigger. Available methods of grid switching are replenishment, replacement, and static grid. Another method of grid switching includes a “grid trigger”, which refers to an event that is configured to have a grid switch to a new iteration, or close the grid. Available methods of grid triggers are top tier, or the selling out of all tickets in a grid.

The present invention can match any commonly used method for replenishing standard instant tickets and includes the ability to distribute tickets based purely upon static probability, such that every player has exactly the same chance of winning at all times.

With top tier replenishment, each ticket sold reduces the size of the grid by one. When a ticket is purchased that randomly hits the final remaining top prize (tier 1), the grid is switched to a new iteration. The new iteration of the grid will include outstanding tickets from the previous iteration in addition to the prize structure template for the new iteration. Top tier replenishment mimics the distribution of traditional instant tickets, where a new pool of tickets is released into the field when the existing tickets have no top prizes remaining.

With top tier replacement, each ticket sold reduces the size of the grid by one. When a ticket is purchased that randomly hits the final remaining top prize (tier 1), the grid is switched to a new iteration. The new iteration of the grid will be created based on the prize structure template. When a grid is replaced, it will contain the same number of tickets as the original prize structure. For traditional instant games, this is equivalent to removing all unsold tickets from the field when there are no more top prizes and then distributing a new pool of tickets.

With grid sell-out replacement, each ticket sold reduces the size of the grid by one. When a ticket is purchased that randomly hits the final remaining prize, the grid is switched to a new iteration. The new iteration of the grid will be created based on the prize structure template. When a grid is replaced, it will contain the same number of tickets as the original prize structure.

With the static grid configuration, as each ticket is sold, the size of the grid remains the same for the next transaction. With this model, the grid remains on iteration 1 for the life of the game or until the game manager changes it. Top tier prizes are always available. Odds at any given time are always the same using the static grid method because the size of the pool never changes as tickets are sold,

As described above, the grid can comprise a logic-based pool comprised of the total number of winning and non-winning tickets, representing the odds of the game's prize structure. In this way, the lottery game provider receives more choices via the game production system, and can select, for example, from static or dynamic (e,g., top tier replenishment, top tier replacement, grid sell-out) grids. The production system assists with management of the integration of game files with winner determinations and internal controls of the present invention. Internal controls can be provided via internal control system (ICS) vendors in accordance with typical lottery system operations. In various embodiments of the present invention, the production engine 70 has its own portal (e.g., a player portal) for offering each lottery customer's games to players. The portal can serve as the player's primary interaction point with his or her lottery when it comes to buying and playing interactive games.

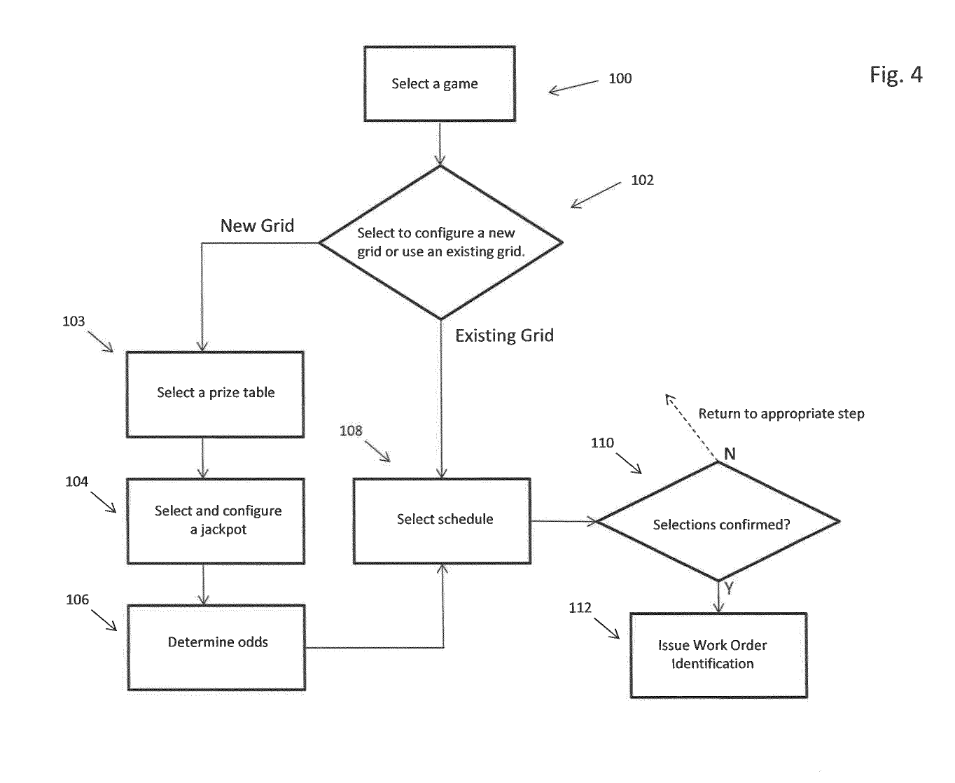

FIG. 4 is a flow diagram illustrating one method for a lottery operator to select a game for implementation using the game market in accordance with one embodiment of the present invention. As shown at step 100, the lottery operator selects a game, which includes the selection of a game mechanic and a presentation layer. In one embodiment of the present invention, the operator can select a single presentation layer to be applied to a plurality of game mechanics, and can then configure each game independently. In another embodiment of the present invention, the operator can select and experiment with different presentation layers in combination with different game mechanics, according to the library of wagering games. In selecting a game, a user can search for an appropriate game candidate by searching according to game name, game rating game mechanic, release date, price point, theme or presentation layer element(s) and other delimiters, for example. In this way, it will be appreciated that a user can make a game selection based on a contribution from a first party in the game development field and/or a contribution from a second party in the game presentation field, such as a contributor 20, 25 to developer network 15 in FIG. 1. At step 102, the operator selects either a new grid to be configured, or an existing grid with an existing configuration. If the operator selects a new grid, then the operator proceeds to select a prize table as at step 103, select and configure a jackpot as at step 104, including the option of selecting and configuring a progressive jackpot, and determine the odds at step 106. The odds determination can he configured by the operator entering the expected number of winners per grid. Steps 103-105 are associated with the user's selection of one or more prize structure selection options. The process then proceeds to the selection of a schedule for the start date for the game, and optionally the end date, as at step 108, and this step is performed whether the operator had elected to create a new grid or selected an existing grid. At step 110, the operator's selections are presented for the operator to confirm accuracy, and if the operator finds something inaccurate, or elects to re-do any of the previous steps, he or she has the option at this step. If the operator confirms the selections, then a work order identification is provided along with a summary of the selected game parameters at step 112, and the game is ready to be finalized and delivered for integration into the selecting lottery operator's operations,

In various embodiments of the present invention, winner determination is controlled by randomly indexing into a given game's grid.

Another example embodiment of the present invention may provide a system including a game repository accessible to a plurality of wagering game operators, the game repository configured to allow the wagering game operators to select games from the game repository to offer to their respective customers; a game repository deposit system configured to allow the entry of new games in the game repository; a game adoption system configured to allow the wagering game operators to adopt the games in the game repository; and an accounting system configured to determine the amount charged to the game operators based at least in part on adoption of the games in the game repository by the game operators. In addition, the accounting system may be further configured to determine an amount due to content developers for games deposited in the game repository based at least in part on adoption of the game by the game operators. In addition, the amount charged to the game operators for a particular game is based at least in part on an amount of usage made by the game operator's player customers of the particular game.

Another example embodiment of the present invention may provide a system including a game repository accessible to a plurality of lottery game operators, the game repository configured to allow the lottery game operators to select lottery games from the game repository to offer to their respective customers; a game repository deposit system configured to allow the entry of new games in the game repository by content developers; a game adoption system configured to allow the lottery game operators to adopt the games in the game repository; and an accounting system configured to determine an amount due to game depositors, for games deposited in the game repository, based at least in part on an amount of use made of the games by the lottery game operators' player customers for games the lottery game operators have adopted from the games in the game repository, the accounting system further configured to determine an amount due to content developers, for the games deposited in the game repository, based at least in part on adoption, by the lottery game operators, of the games deposited in the game repository, and further configured to determine an amount chanted to the lottery game operators for a particular game, based at least in part on an amount of usage made by the lottery game operators' player customers of the particular game.

Another example embodiment of the present invention may provide an article of manufacture comprising a computer-readable medium having stored thereon a series of instructions executable by a processor, the instructions configured to cause the performance of any of the example procedures described herein.

Although games and game content from the shared host may be used by multiple game operators, game customization may also be provided, e,g., with a customization interface and engine that is accessible to the game operators when shared games are activated. This may allow the game operators to provide unique attributes to games and branding in the content that makes their version distinct and hopefully most desirable to their player base, but without having to redevelop the game code and content for each game operator or jurisdiction as is the case today. Localization and branding capabilities may be provided in the various games, e.g., using standard tools or re-usable objects that may be included in the different games. Each participating game operator may then configure the aspects of the games provided through the shared host that content developers have made available. The game operators can also develop and publish their lottery branding components (e.g., the game operator name, slogans, logos, legal disclaimers, etc.) as discussed below. These game operator specific components may be combined with the common shared content published by the content developers to create a unique game experience for each game operator.

Some example embodiments also provide features which allow games provided by the shared central server, operated by a first service provider, to be provided via a proprietary host system, e.g., a lottery operated under contract by another service provider. Within the current lottery industry, it is difficult or impossible for games from one vendor to be accessed via another vendor's system. Instead, each vendor develops their own version of any common games. However, in the example embodiments, by the addition of a pass-through engine or other add-on feature, content from the shared host may be provided through the proprietary legacy host system of another vendor. Also, multi-jurisdiction games can be provided more efficiently from a single shared host.

Example embodiments of the present invention, some of which are described below, can be used to support regulated state or governmental lotteries, private gaming corporations, both physical and Internet casinos, or other entities that provide legal gaming to customers. While the examples are described principally with reference to regulated state lotteries, it will be appreciated that the same solutions may be applied in other wagering or regulated gaming applications. The example embodiments described below include references to host systems. Host systems may he implemented as a single computing system or as a collection of computing systems which are communicatively coupled. Thus, each component of the exemplary shared hosts may be implemented in hardware, software, or a combination thereof,

It will be appreciated that, in accordance with aspects of the present invention, games can have at least three components: (1) the game logic, which can include a set of game rules and mathematics that control the execution of the wagering on the game and determination of game outcome (winners and payouts), (2) game play presentation, which depending on the channel type (e.g., retailer channel, online channel, player channel) can be either player facing or retailer facing, but in either case involves a user interface to gather (and in some cases distribute) the information related to wagering on the game, and (3) results reveal presentation, which is the part of the game that delivers the information about game results to the player. Each of these elements can have technical implementation components which together make up the overall technical implementation of a game,

The game logic (math and business rules) can be implemented on a host system and provided to the lottery developer network as indicated at 26 in FIG. 1. The presentation aspect is provided by developers as described above. The inputs, e.g., player choice of type of bet and numbers to bet in a future draw lottery game, can include bet slips, manual entry of player selections by the retailer or quick picks (random selections by the terminal or host system) via retailer input. In some cases, player cards or other devices can be used by players as a part of the process to place favorite bets or communicate other input information. The results of the wagers and other game transactions can generally be communicated to the player via receipts or electronic messages that include all of the relevant information about the wager.

Software as a service (SaaS) is a software application delivery model whereby a software vendor develops a web-native software application and hosts and operates (either independently or through a third-party) the application for use by its customers over the Internet, Customers access the software via a web-based API such as Web Services or REST (representational state transfer). SaaS provides a low-cost alternative for businesses to obtain the same benefits of commercially licensed, internally operated, on-premise software. SaaS is attractive to users because it may provide a quicker deployment model, minimize up-front investment, and lower risk for exploration of new business markets. Sonic example embodiments of the present invention extend SaaS concepts to use in wagering game deployment and operation, e.g., providing wagering game development, selection and customization as a service,

Some example embodiments of the present invention can provide secure network-based wagering game applications, e.g., lottery games deployed and accessed by one or more game operators, e.g., governmental lotteries, as shared hosted (off premise)services, Games implemented and deployed on a shared hosted service architecture and associated shared content frameworks can be accessed by one or more game operators, e.g., lottery jurisdictions, that subscribe to the service. Subscriptions can be fixed price, per game, or based on amount or dollar volume of usage, or a blend of these or other pricing approaches. Game operators can access the shared services via shared service-enabled components within existing infrastructure or via dedicated shared service components deployed both directly in point-of-sale and in interactive environments. The shared service architecture and associated content frameworks described in the present application can also support the authoring of shared service games and content by third party developers and content producers. These developers can use a game development kit (GDK) which may include shared game and content frameworks, APIs, and game developer tools to author shared content for traditional retail point-of-sale and interactive channels such as iPC, Mobile, and

In the shared game service, game logic can be separated from the entertainment experience presented directly to player customers. This separation enables developers to author appropriate entertainment presentation content for target access devices while leveraging the same game and business logic code across different channels, Games can be implemented as single jurisdictional, multi-jurisdictional (e.g., where players in multiple jurisdictions compete for the same prize), with shared services and content, and with shared or separate data storage. Further, presentation layers can be adapted to multiple game mechanics.

The shared host can receive and confirm licensing information from the operator. The interface may provide an option to select one or more licensing agreements. The terms of the agreement(s) can be selected or modified by the operator. Once this information is received, the shared host may confirm that the terms are acceptable and may issue a confirmation notice to the operator.

It will be appreciated that all of the disclosed methods, games, and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods, games, and procedures.

It will be appreciated that, in the above descriptions, reference has been made to “random numbers” and “random number generation.” It will be appreciated that this recitation includes both random sampling of physical events, the use of a computer software pseudo random number generator a firmware or hardware random or pseudo random number generator, or the reference to external real world events that are effectively random for the purposes of the game, e.g., the least significant digit in the total trading volume on a stock exchange. Access may also be provided to a secure random number generator outside the system itself, e.g., a utility or service that provides the results of random external events, such as ball drawings used in conventional Lotto type games or pseudo-random numbers generated on another computer system, or access to other information that while not perhaps not technically random in a purely theoretical mathematical sense, is unknowable in advance and effectively random for the purpose of the game, e.g., reference to particular sports or financial information, such as the last (least significant) digit in the total stock sales on the New York stock exchange, or the last (least significant) digit of the total number of pitches thrown in all the major league baseball games on a particular day. Where “random numbers” are referred to in the present application, it should be understood, unless expressly indicated otherwise, that any of the above approaches to random number generation are intended to be included. It is also appreciated that, the random numbers can be used to determine game outcomes; however, the determination, unless specifically required by the language of the claims need not be done in any particular location, it may he on a dedicated machine, a server, accessed over a network, etc.

The foregoing descriptions of the example embodiments of the present invention reference the terms “communications” and “in communication with”. As used throughout the specification of the present application, these terms refer to device or system components which are in electrical or optical communication with each other. This may include both digitial and analog communication, both synchronous and asynchronous communication, and may be wired as web as wireless communication, using both direct (e.g., device-to-device) and indirect (e.g., networked through an intermediate device) communication.

1. A method for facilitating presentation layer development for interactive lottery games, comprising:
providing a developer network in communication with one or more presentation layer developers;
providing a shared library of game mechanics for selection by the one or more presentation layer developers;
providing a shared library of available configuration options for the selected game mechanic including one or more prize structure setting options; and
receiving a presentation layer integrated with a game mechanic from a presentation layer developer.

2. The method of claim 1 wherein receiving a presentation layer includes receiving a list of at least one supported configuration option.

3. The method of claim 1 wherein the game mechanic is pre assigned to a price for a wager.

4. The method of claim 1 wherein the game mechanic has more than one result for a wager request.

5. A method for facilitating selection of wagering games by wagering game operators, comprising:
providing a game market component in communication with a plurality of game operators;
providing a shared library of wagering games accessible via the game market component and available for selection by the plurality of game operators, wherein each of the wagering games comprises a presentation layer integrated with a game mechanic;
providing a shared library of game configuration options accessible via the game market component and available for selection by the plurality of game operators, wherein the shared library of game configuration options includes at least a prize structure selection option; and
receiving a request from a game operator from the plurality of game operators to configure a selected wagering game, including a selection of a game from the library of wagering games and a selection of a prize structure selection option from the library of game configuration options.

6. The method of claim 5 including the step of providing a presentation developer compensation component adapted to calculate revenue share compensation for the one or more presentation developers,

7. The method of claim 5 wherein the shared library of wagering games comprises electronic instant ticket games,

8. The method of claim 5 wherein the request comprises a selection of a presentation layer to be applied to a plurality of selected wagering game mechanics,

9. The method of claim 5 wherein the shared library of wagering games includes at least a demonstration and certification support for each game of the wagering games.

10. The method of claim 5 wherein the game market component includes programming permitting the game operator to associate one or more presentation layers with one or more game mechanics prior to making a selection for use in a requested game,

11. The method of claim 5 wherein the selection of a game configuration option includes a prize grid selection, a prize table selection, a progressive jackpot selection option, an odds of winning selection and a start and end date selection.

12. A system for facilitating selection of wagering games by wagering game operators, comprising:
a game market component accessible to a plurality of game operators, with the game market component providing a wagering game library and a game configuration option library, wherein the game library comprises a plurality of wagering games each comprising a presentation layer integrated with a game mechanic; and
a game configuration engine for receiving one or more requests from a game operator from the plurality of game operators to configure a wagering game, and a selection of a game configuration option from the library of game configuration options, wherein the game configuration option includes at least a prize structure selection.

13. The system of claim 12 further including a game presentation developer network application programming interface for receiving games from a lottery developer network.

14. A system for facilitating the selection of game offerings to game operators, comprising:
a game market component accessible to a plurality of game operators, with the game market component providing a wagering game library and one or more game configuration options;
a prize grid selection interface permitting a game operator to select a previously existing prize grid or to create a new prize grid;
a prize table selection interface;
a progressive jackpot option interface;
an odds of winning selection interface;
a start and end date selection interface;
a game selection interface; and
a game presentation layer selection interface.

15. The system of claim 14 wherein the game selection interface includes a demonstration and certification support for a selected game.

16. The system of claim 14 wherein the game presentation layer selection interface permits filtering by presentation theme, price point, creation date and performance history.

17. The system of claim 14 wherein the prize grid selection interface permits selection of a prize grid from at least one of: top tier replenishment structure; top tier replacement structure; sell-out replacement structure; static structure,

18. The system of claim 14 further including a game developer compensation component adapted to calculate revenue share compensation for one or more game developers.
